(19) United States
(12) Patent Application Publication
(10) Pub. No.: US 2005/0182831 A1
(43) Pub. Date: Aug. 18, 2005

(54) Configuration display apparatus for computer, computer configuration display method, and computer configuration display program

(75) Inventors: Hirohisa Uchida, Kawasaki (JP); Daisuke Hoshi, Kawasaki (JP); Yasuhiro Matsumura, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 11/066,460

(22) Filed: Feb. 28, 2005

Related U.S. Application Data
(63) Continuation-in-part of application No. 10/848,133, filed on May 19, 2004.

(30) Foreign Application Priority Data
Jan. 20, 2004 (JP) 2004-011439
Jan. 6, 2005 (JP) 2005-001397

(51) Int. Cl. G06F 15/177

(52) U.S. Cl. 709/220; 709/223; 717/121

(57) ABSTRACT

The present invention provides a computer configuration display apparatus, a computer configuration display method, and a computer configuration display program that can contribute to reduction of a burden on a system administrator who performs management concerning physical components and logical components of a computer. The computer configuration display apparatus includes: a hierarchical data association unit that associates physical hierarchical data, which defines plural physical components of a computer as plural hierarchical data according to a predetermined physical segmentation, and logical hierarchical data, which defines plural logical components of the computer as plural hierarchical data according to a predetermined logical segmentation, with each other; a hierarchical data setting unit that sets the associated physical hierarchical data and logical hierarchical data; and a hierarchical data display unit that displays the physical hierarchical data and the logical hierarchical data set in the hierarchical data setting unit.

### BACKGROUND OF THE INVENTION

1. Field of the Invention

The present invention relates to a computer configuration display apparatus, a computer configuration display method, and a computer configuration display program.

2. Related Background Art

Conventionally, management work for a computer has problems as described below (e.g., see pages 5 to 8 and FIG. 1 of Japanese Patent Application Laid-Open No. 2001-282632, pages 2 to 4 and FIG. 1 of Japanese Patent Application Laid-Open No. 11-212826, and pages 4 to 11 and FIG. 1 of Japanese Patent Application Laid-Open No. 10-294731).

In a computer system that is required to operate stably for 24 hours in 365 days, in the event that a physical component of a computer or a logical component from the viewpoint of an OS installed in the computer has fallen into a state that adversely affects the computer (an error or the like), a cause for the component having fallen into the state has to be specified and removed.

Moreover, in order to grasp what kind of situation the computer is brought into by the state, it has to be specified which range of a physical configuration and a logical configuration of the computer is affected by the state.

It may take time to specify a cause of the state, for example, in the case in which the physical configuration or the logical configuration of the computer is complicated.

In addition, it may be difficult to judge which of the physical component and the logical component has caused the state because, conventionally, the physical configuration and the logical configuration of the computer are not clearly divided. Moreover, it may take time to specify which range of the physical configuration and the logical configuration is affected by this state.

Such work, which specifies a cause of the state and an range of the physical configuration and the logical configuration to be affected by the state, is required to be carried out promptly in order to prevent processing efficiency in the computer from falling. This is a burden for a system administrator.

### SUMMARY OF THE INVENTION

The present invention has been devised in order to solve the above-described problems, and it is an object of the present invention to provide a computer configuration display apparatus, a computer configuration display method, and a computer configuration display program that can contribute to reduction of a burden on a system administrator who performs management concerning physical components and logical components of a computer:

In order to solve the problems, a computer configuration display apparatus in accordance with the present invention is characterized by including: a hierarchical data association unit that associates physical hierarchical data, which defines plural physical components of a computer as plural hierarchical data according to a predetermined physical segmentation, and logical hierarchical data, which defines plural logical components of the computer as plural hierarchical data according to a predetermined logical segmentation, with each other; a hierarchical data setting unit that sets the associated physical hierarchical data and logical hierarchical data; and a hierarchical data display unit that displays the physical hierarchical data and the logical hierarchical data set in the hierarchical data setting unit.

With such a constitution, a physical configuration and a logical configuration of the computer, which have not been clearly divided conventionally, can be managed as individual hierarchical data, and a correspondence relation between the physical hierarchical data and the logical hierarchical data can be grasped easily. This results in contributing to reduction of a burden on a system administrator who performs management concerning the physical components and the logical components of the computer. Note that the plural hierarchical data in this context are preferably hierarchical data of a tree structure.

In the computer configuration display apparatus as described above, it is also possible to include a storage unit that stores correspondence relation data defining the correspondence relation between the physical hierarchical data and the logical hierarchical data, wherein the hierarchical data association unit associates the physical hierarchical data and the logical hierarchical data with each other on the basis of the correspondence relation data.

In addition, in the computer configuration display apparatus as described above, it is preferable to include a state detection unit that detects states of the physical components and the logical components of the computer, wherein the hierarchical data display unit displays a component, for which a state is detected by the state detection unit, with the detected state reflected thereon, and displays components of hierarchies higher in order than a hierarchy, to which an arbitrary component belongs, with a state of the arbitrary component reflected thereon.

With such a constitution, a state of each component in the hierarchical data can be grasped easily. In addition, since a state of each component is reflected on components of hierarchies higher in order than a hierarchy to which the component belongs, the system administrator can specify a component, which has fallen into the state, easily by tracing down hierarchies while selecting a component, for which the state is displayed, among the components in the higher in order hierarchies.

In addition to the above, in the computer configuration display apparatus with the above-described constitution, the hierarchical data display unit may display a physical component and a logical component, which are associated with each other, with a state of one of the physical component and the logical component reflected on the other.

With such a constitution, for example, in the event that a state of an error or the like has occurs in a certain physical component, it can be easily grasped which component in logical hierarchical data this error will affect. It goes without saying that the state is also reflected on logical components of hierarchies higher in order than a hierarchy to which a logical component, on which the state is reflected in this way, belongs. Consequently, a system administrator can easily grasp a range to be affected by a state that has occurred in a certain component.

A computer configuration display apparatus in accordance with the present invention includes: a hierarchical data association unit that associates physical hierarchical data, which defines plural physical components of a computer as plural hierarchical data according to a predetermined physical segmentation, and logical hierarchical data, which defines plural logical components of the computer as plural hierarchical data according to a predetermined logical segmentation, with each other; a hierarchical data setting unit that sets the associated physical hierarchical data and logical hierarchical data; a hierarchical data display unit that displays the physical hierarchical data and the logical hierarchical data set in the hierarchical data setting unit; and a state detection unit that detects states of the physical components and the logical components of the computer, wherein, when a state of a specific component is detected by the state detection unit, the hierarchical data display unit reflects and displays the detected state in a predetermined display area that is an area, which is displayed when any of the physical hierarchical data and the logical hierarchical data is displayed, and corresponds to hierarchical data to which the specific component belongs. With such a constitution, when any of the physical hierarchical data and the logical hierarchical data is displayed, a user is capable of grasping a state of a specific component in any one of the hierarchical data on the basis of displayed contents reflected in a predetermined display area.

In the computer configuration display apparatus with the constitution described above, it is also possible that the specific component is at least one of the physical component and the logical component and is a component that is not in a predetermined correspondence relation with the other. Note that it is preferable that the predetermined correspondence relation is a relation in which a state of one of the physical component and the logical component has a predetermined influence on a state of the other.

In the computer configuration display apparatus with the constitution described above, it is also possible that the hierarchical data display unit switchably displays the physical hierarchical data and the logical hierarchical data associated with each other by the hierarchical data association unit and reflects and displays a state, which is detected for the specific component in the other hierarchical data when one hierarchical data of the physical hierarchical data and the logical hierarchical data is displayed, in the predetermined display area. According to such a constitution, it is possible to grasp a change of a state in hierarchical data, which is in a state in which the hierarchical data cannot be visually recognized because of switching of display to any one of the hierarchical data, without switching display of the hierarchical data.

In the computer configuration display apparatus with the constitution described above, it is also possible that the predetermined display area is a tab section that is displayed in association with the physical hierarchical data and the logical hierarchical data, individually.

In the computer configuration display apparatus with the constitution described above, it is preferable that the computer configuration display apparatus includes an urgency judging unit that judges a degree of urgency of a state detected by the state detection unit, and the hierarchical data display unit reflects and displays the detected state in a predetermined display area on the basis of the degree of urgency judged by the urgency judging unit. With such a constitution, when a change occurs in a state of a component in hierarchical data that is not displayed presently, it is possible to grasp a degree of urgency of a change in the state easily.

In the computer configuration display apparatus with the constitution described above, it is also possible that, when states for plural specific components in the hierarchical data are detected by the state detection unit, the hierarchical data display unit reflects and displays a state with a highest degree of urgency judged by the urgency judging unit in the predetermined display area. With such a constitution, when a change in a state occurs in plural specific components simultaneously, it is possible to avoid a situation in which a change in a state with a high degree of urgency (occurrence of abnormality, etc.) is overlooked because a state with a low degree of urgency is displayed in the predetermined display area.

In the computer configuration display apparatus with the constitution described above, it is desirable that, in the case in which the state of the specific component in the physical hierarchical data or the logical hierarchical data is reflected and displayed in the predetermined display area, when it is detected by the state detection unit that the states of all the specific components in the physical hierarchical data or the logical hierarchical data are a predetermined normal state, the hierarchical data display unit changes display for reflecting the state in the predetermined display area to display corresponding to the predetermined normal state. With such a constitution, when a state of a specific component is returned to the predetermined normal state, it is possible to cause a user to grasp that the state is returned to the normal state.

In the computer configuration display apparatus with the constitution described above, it is possible that the specific component is at least one of a cooling fan and a power supply that are physical components.

A computer configuration display method in accordance with the present invention includes: a hierarchical data association step of associating physical hierarchical data, which defines plural physical components of a computer as plural hierarchical data according to a predetermined physical segmentation, and logical hierarchical data, which defines plural logical components of the computer as plural hierarchical data according to a predetermined logical segmentation, with each other; a hierarchical data setting step of setting the associated physical hierarchical data and logical hierarchical data; a hierarchical data display step of displaying the physical hierarchical data and the logical hierarchical data set in the hierarchical data setting step; and a state detection step of detecting states of the physical components and the logical components of the computer, wherein, when a state of a specific component is detected in the state detection step, in the hierarchical data display step, the detected state is reflected and displayed in a predetermined display area that is an area, which is displayed even when any of the physical hierarchical data and the logical hierarchical data is displayed, and corresponds to hierarchical data to which the specific component belongs.

In addition, a computer configuration display program in accordance with the present invention is characterized by causing a computer to execute: a hierarchical data association step of associating physical hierarchical data, which defines plural physical components of a computer as plural hierarchical data according to a predetermined physical segmentation, and logical hierarchical data, which defines plural logical components of the computer as plural hierarchical data according to a predetermined logical segmentation, with each other; a hierarchical data setting step of setting the associated physical hierarchical data and logical hierarchical data; and a hierarchical data display step of displaying the physical hierarchical data and the logical hierarchical data set in the hierarchical data setting step.

A computer configuration display program in accordance with the invention is a computer configuration display program that causes a computer to execute: a hierarchical data association step of associating physical hierarchical data, which defines plural physical components of a computer as plural hierarchical data according to a predetermined physical segmentation, and logical hierarchical data, which defines plural logical components of the computer as plural hierarchical data according to a predetermined logical segmentation, with each other; a hierarchical data setting step of setting the associated physical hierarchical data and logical hierarchical data; a hierarchical data display step of displaying the physical hierarchical data and the logical hierarchical data set in the hierarchical data setting step; and a state detection step of detecting states of the physical components and the logical components of the computer, wherein, when a state of a specific component is detected in the state detection step, in the hierarchical data display step, the detected state is reflected and displayed in a predetermined display area that is an area, which is displayed when any of the physical hierarchical data and the logical hierarchical data is displayed, and corresponds to hierarchical data to which the specific component belongs.

### BRIEF DESCRIPTION OF THE DRAWINGS

In the accompanying drawings:

FIG. 1 is a functional block diagram for explaining a structure of a computer configuration display apparatus according to an embodiment of the present invention;

FIG. 2 is a diagram for explaining logical hierarchical data to be set in a hierarchical data setting unit;

FIG. 3 is a diagram for explaining physical hierarchical data to be set in the hierarchical data setting unit;

FIG. 4 is a diagram for explaining attributes inherent in components in logical hierarchical data and physical hierarchical data;

FIG. 5 is a diagram for explaining correspondence relation data that defines a correspondence relation between the physical hierarchical data and the logical hierarchical data;

FIG. 6 is a flowchart for explaining operations of the computer configuration display apparatus according to this embodiment;

FIG. 7 is a diagram for explaining processing for reflecting a state, which is detected by a state detection unit, on a component;

FIG. 8 is a diagram for explaining the processing for reflecting a state, which is detected by the state detection unit, on a component;

FIG. 9 is a diagram for explaining the processing for reflecting a state, which is detected by the state detection unit, on a component;

FIG. 10 is a diagram for explaining the processing for reflecting a state, which is detected by the state detection unit, on a component;

FIG. 11 is a diagram for explaining the processing for reflecting a state, which is detected by the state detection unit, on a component;

FIG. 12 is a diagram for explaining the processing for reflecting a state, which is detected by the state detection unit, on a component;

FIG. 13 is a diagram for explaining the processing for reflecting a state, which is detected by the state detection unit, on a component;

FIG. 14 is a diagram for explaining the processing for reflecting a state, which is detected by the state detection unit, on a component;

FIGS. 15A and 15B are diagrams for explaining a structure of physical hierarchical data;

FIG. 16 is a diagram showing an example of notification to a user with a dialog box;

FIG. 17 is a functional block diagram for explaining a structure of a computer configuration display apparatus according to a second embodiment of the invention;

FIG. 18 is a flowchart for explaining a flow of processing in a computer configuration display method according to the embodiment;

FIG. 19 is a diagram showing an example of display at the time when a failure state has occurred in a cooling fan and a power supply;

FIG. 20 is a diagram showing examples of types of an urgency level and icon display that are set in association with the respective urgency levels;

FIG. 21 is a diagram for explaining display in which states of components are reflected by a hierarchical data display unit; and

FIG. 22 is a diagram for explaining display in which states of components are reflected by the hierarchical data display unit.

### DETAILED DESCRIPTION OF THE PREFERRED EMBODIMENTS

An embodiment of the present invention will be hereinafter described with reference to the accompanying drawings.

(First Embodiment)

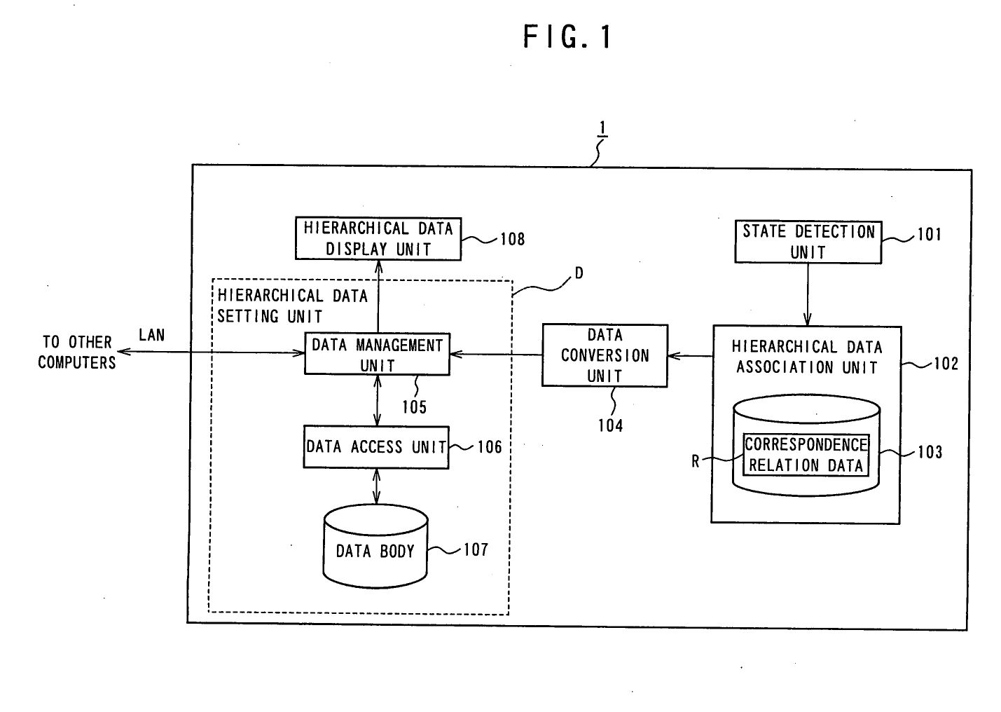

FIG. 1 is a functional block diagram for explaining a structure of a computer configuration display apparatus according to an embodiment of the present invention.

A computer configuration display apparatus 1 according to the present embodiment is an apparatus that, in order to perform management of a computer having plural physical components and logical components, performs display concerning components of the computer. Here, the computer configuration display apparatus 1 is arranged inside the computer.

The computer configuration display apparatus 1 includes a state detection unit 101, a hierarchical data association unit 102, a data conversion unit 104, a hierarchical data setting unit D, a hierarchical data display unit 108, a not-shown storage area, and a not-shown CPU.

The hierarchical data association unit 102 plays a role of creating various data concerning a computer to be managed. For example, the hierarchical data association unit 102 associates physical hierarchical data, which defines plural physical components of a computer as plural hierarchical data according to a predetermined physical segmentation, and logical hierarchical data, which defines plural logical components of the computer as plural hierarchical data according to a predetermined logical segmentation, with each other. Note that details of the physical hierarchical data and the logical hierarchical data will be described later.

The state detection unit 101 plays a role of detecting states of the physical components and the logical components of the computer. The states in this context include abnormalities (errors), which occur in the physical components (hardware) or the logical components (software), or changes to the physical components or the logical components. Note that in the event that a state of an error or the like is detected in the state detection unit 101, the state detection unit 10 sends information on the state to the hierarchical data association unit 102.

The data conversion unit 104 plays a role of converting data such as hierarchical data, which is associated by the hierarchical data association unit 102, into a data format that can be stored in a data body 107.

The hierarchical data setting unit. D is a database that sets (stores) the physical hierarchical data and the logical hierarchical data that are associated by the hierarchical data association unit 102.

The hierarchical data display unit 108 includes, for example, a CRT, a liquid crystal display, or the like, and is capable of displaying the physical hierarchical data and the logical hierarchical data that are set in the hierarchical data setting unit D.

In addition, the hierarchical data setting unit D includes: a data management unit 105 that requests a data access unit 106, which controls communication among the hierarchical data display unit 108, the data conversion unit 104, and the data body 107 (to be described later), to perform processing; a data access unit 106 that writes data in and reads data from the data body 107 and performs exclusion processing involved in the writing and the reading; and the data body 107 that stores the physical hierarchical data, the logical hierarchical data, and the like. The data body 107 is constituted by a storage area such as an HDD. Note that the data management unit 105 can be communicatably connected to a computer configuration display apparatus that is arranged in another computer different from the computer in which the computer configuration display apparatus 1 is arranged. The computer configuration display apparatus, which is arranged in another computer, has the same configuration as the computer configuration display apparatus 1 such that data management units of both the computer configuration display apparatuses can communicate with each other via an electric communication line (LAN, the Internet, etc.).

Consequently, the physical hierarchical data and the logical hierarchical data of the computer, in which the computer configuration display apparatus 1 is arranged, can be monitored by the hierarchical data display unit in another computer.

The storage unit 103 plays a role of storing correspondence relation data R that defines a correspondence relation between the physical hierarchical data and the logical hierarchical data. The hierarchical data association unit 102 associates the physical hierarchical data and the logical hierarchical data with each other on the basis of the correspondence relation data R. The storage unit 103 is constituted by a storage area such as a RAM, an HDD, or the like.

Note that, here, the hierarchical data setting unit D and the hierarchical data display unit 108 are arranged in the computer to be managed. However, the present invention is not limited to this structure. At least one of or both of the hierarchical data setting unit D and the hierarchical data display unit 108 may be arranged outside the computer.

Note that, in the case in which the hierarchical data display unit 108 displays hierarchical data, when the hierarchical data display unit 108 requests the data management unit 105 to acquire data, the data management unit 105 requests the data access unit 106 to acquire the data. The data access unit 106 acquires the data from the data body 107 and delivers the data to the data management unit 105. The data management unit 105 sends the received data to the hierarchical data display unit 108, which displays the received data on a screen.

Next, logical hierarchical data and physical hierarchical data to be set by the hierarchical data setting unit D will be described.

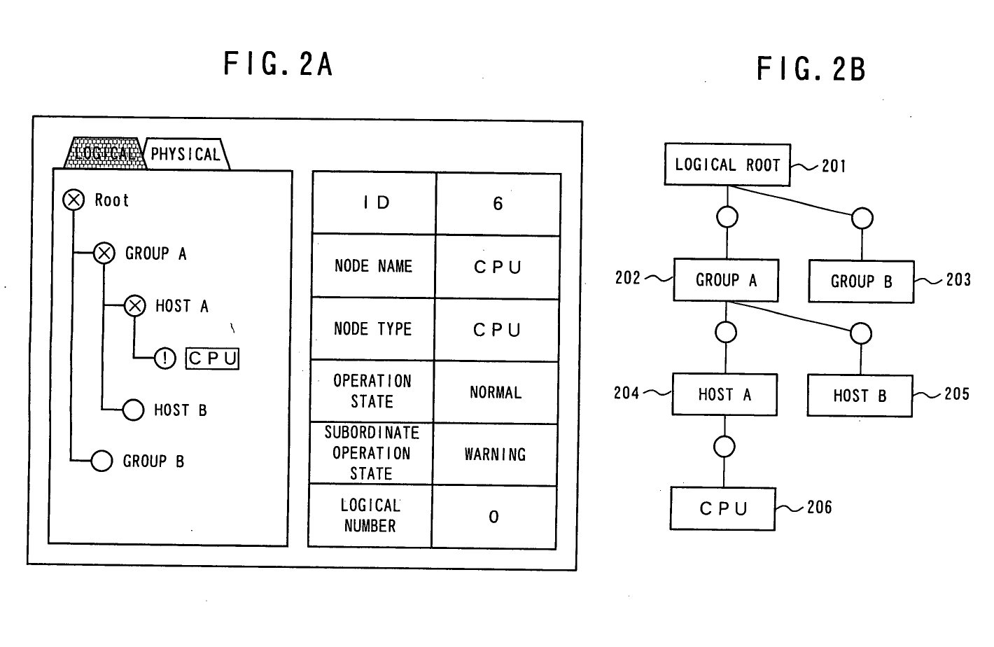

FIG. 2A shows an example of a display screen in the, case in which logical hierarchical data to be set in the hierarchical data setting unit is displayed by the hierarchical data display unit 108. FIG. 2B is a conceptual diagram of an example of logical hierarchical data of the computer in which the computer configuration display apparatus 1 is arranged.

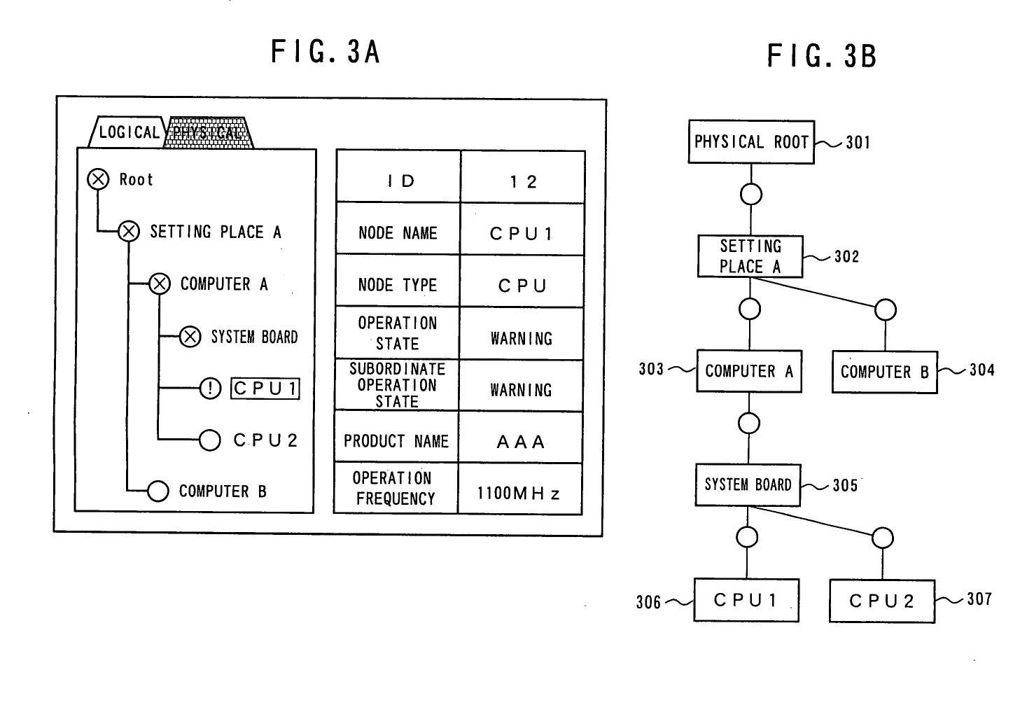

In addition, FIG. 3A shows an example of a display screen in the case in which physical hierarchical data to be set in the hierarchical data setting unit is displayed by the hierarchical data display unit 108. FIG. 3B is a conceptual diagram of an example of physical hierarchical data of the computer in which the computer configuration display apparatus 1 is arranged.

As shown in FIGS. 2B and 3B, the logical hierarchical data has a hierarchical tree structure constituted by plural logical components, and the physical hierarchical data has a hierarchical tree structure constituted by plural physical components.

As shown in FIGS. 2A and 3A, these hierarchical data are displayed by the hierarchical data display unit 108. In the hierarchical data that is displayed in a form of a tree in this way, the respective components constituting the hierarchical data are made selectable. The respective components constituting the hierarchical data have attribute data, which is information on the components. Attribute data of a selected component is displayed beside the tree display.

In addition, the physical hierarchical data and the logical hierarchical data, which are associated with each other by the hierarchical data association unit, are displayed by the hierarchical data display unit 108 such that the physical hierarchical data and the logical hierarchical data can be switched. Note that, when any one of the physical components is selected to switch display to the logical hierarchical data in a state in which the physical hierarchical data is displayed, all logical components corresponding to the selected physical component are displayed in a state in which the logical components are selected. Similarly, when display is switched to the physical hierarchical data in a state in which a logical component is selected, all physical components corresponding to the selected logical component are displayed in a state in which the physical components are selected.

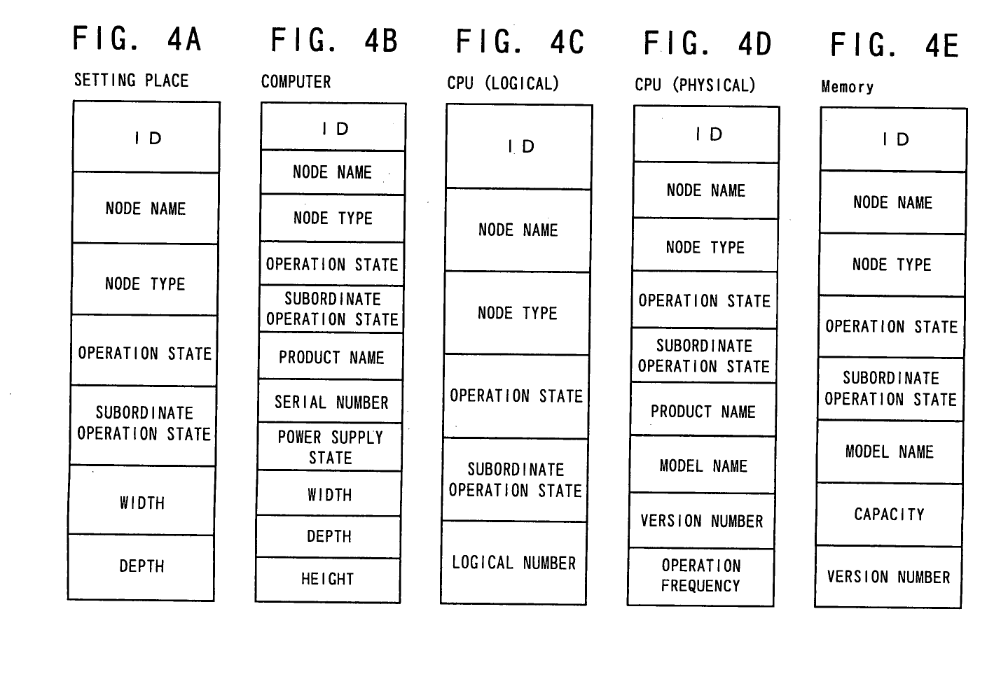

FIG. 4 shows an example of attributes inherent in components in logical hierarchical data and physical hierarchical data. Each component has attributes as data of a table format. Information to be stored in the table is different depending upon what the component represents.

FIG. 4A shows attribute data of a component “setting place” in the physical hierarchical data. The attribute data includes items “ID”, “node name”, “node type”, “operation state”, “subordinate operation state”, “width”, and “depth”.

FIG. 4B shows attribute data of a component “computer” in the physical hierarchical data. The attribute data includes items “ID”, “node name”, “node type”, “operation state”, “subordinate operation state”, “product name”, “serial number”, “power supply state”, “width”, “depth”, and “height”.

FIG. 4C shows attribute data of a component “CPU” in the logical hierarchical data. The attribute data includes items “ID”, “node name”, “node type”, “operation state”, “subordinate operation state”, and “logical number”.

FIG. 4D shows attribute data of a component “CPU” in the physical hierarchical data. The attribute data includes items “ID”, “node name”, “node type”, “operation state”, “subordinate operation state”, “product name”, “model name”, “version number”, and “operating frequency”.

FIG. 4E shows attribute data of a component “Memory” in the physical hierarchical data. The attribute data includes “ID, “node name”, “node type”, “operation state”, “subordinate operation state”, “model name”, “capacity”, and “version number”.

Among these attribute data items, “ID” means a value, which is determined uniquely, for identifying the component on a database, “node name” means a label name that is displayed when the attribute data is displayed in a form of a tree, “node type” means what the component represents (e.g., CabinetServer in the case of a computer, and CPU in the case of a CPU), “operation state” means an operation state of the component (normal, error, warning, etc.), and “subordinate operation state” means an operation state of a component subordinate to the component.

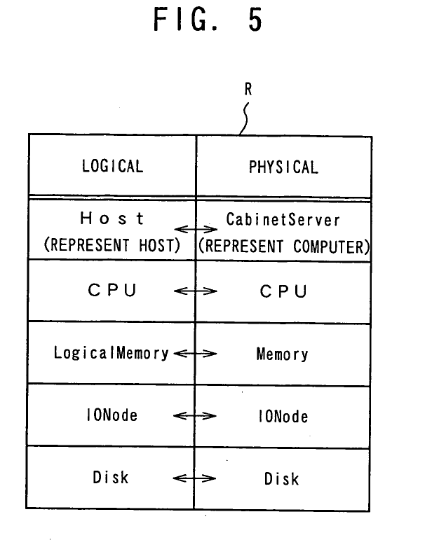

FIG. 5 is a diagram showing an example of the correspondence relation data R that defines a correspondence relation between physical hierarchical data and logical hierarchical data. In the correspondence relation data R in this context, Host, CPU, LogicalMemory, lONode, and Disk in the logical hierarchical data are associated with CabinetServer, CPU, Memory, lONode, and Disk in the physical hierarchical data, respectively. Note that the correspondence relation among the components is judged using node types. In other words, the figure shows a correspondence relation of node types that are defied as corresponding with each other among the logical components and the physical components.

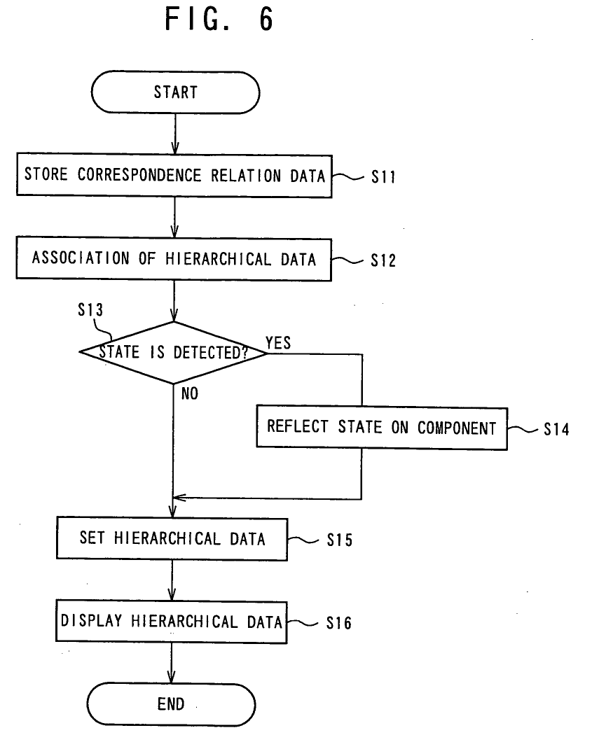

FIG. 6 is a flowchart for explaining operations of the computer configuration display apparatus according to this embodiment.

First, the correspondence relation data R, which defines a correspondence relation between physical hierarchical data and logical hierarchical data of a computer to be monitored, is stored in the storage unit 103 in advance (storage step) (S11).

Next, the physical hierarchical data and the logical hierarchical data of the computer are associated with each other by the hierarchical data association unit 102 on the basis of the correspondence relation data R (hierarchical data association step) (S12).

Subsequently, states (presence or absence of an error or warning, etc.) of physical components and logical components of the computer are detected by the state detection unit 101 (state detection step) (S13).

Here, if some state has been detected (S13, Yes), the detected state is reflected on a component for which the state is detected by the state detection unit 101 (S14). Note that, as processing for reflecting the detected state, a flag representing the state may be set for data concerning the component by the hierarchical data association unit 102, or the state may be reflected on the component when the data is displayed on a screen in a hierarchical data display step to be described later.

After reflecting the detected state (S14), or if no state has been detected (S13, No), the physical hierarchical data and the logical hierarchical data, which are associated by the hierarchical data association unit 102, are set (stored) by the hierarchical data setting unit D (hierarchical data setting step) (S15).

Then, the physical hierarchical data and the logical hierarchical data set in the hierarchical data setting unit D are displayed by the hierarchical data display unit 108 (hierarchical data display step) (S16).

As described above, a computer configuration display method according to this embodiment includes: a hierarchical data association step of associating physical hierarchical data, which defines plural physical components of a computer as plural hierarchical data according to a predetermined physical segmentation, and logical hierarchical data, which defines plural logical components of the computer as plural hierarchical data according to, a predetermined logical segmentation, with each other; a hierarchical data setting step of setting the associated physical hierarchical data and logical hierarchical data; and a hierarchical data display step of displaying the physical hierarchical data and the logical hierarchical data set in the hierarchical data setting step.

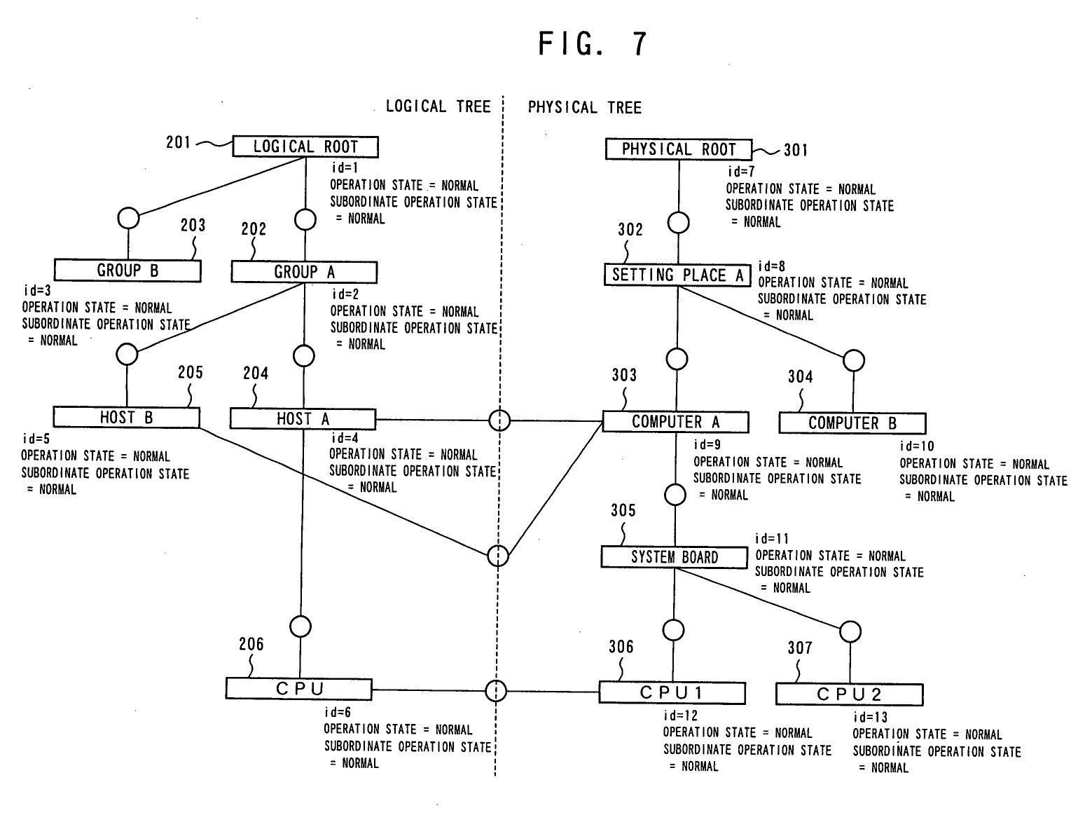

With reference to FIGS. 7 to 14, details of processing for reflecting a state of a certain component detected by the state detection unit on other components will be hereinafter described.

FIG. 7 shows an example of a conceptual diagram of physical hierarchical data and logical hierarchical data of a computer that are associated with each other by the hierarchical data association unit 102. The figure shows an initial state in which a state of an error or the like is not detected by the state detection unit 101.

In the figure, logical hierarchical data and physical hierarchical data are constituted by data holding objects (hereinafter, nodes), which hold data (the attribute data, etc. shown in FIG. 4), and connection objects, which represent connection relations among the data holding objects. The data holding objects correspond to the components. Here, the data holding objects are represented by squares, and the connection objects are represented by circles.

The connection objects hold information on nodes, which the objects are about to connect, and information on what kinds of connection relations the nodes will have. As the information representing the connection relations, there are “connection between physical components”, “connection between logical components”, “connection between a physical component and a logical component”, and the like.

The hierarchical data as shown in the figure is generated by processing described in (1) to (4) below. (1) The hierarchical data association unit 102 generates data and sends the data to the data conversion unit 104. (2) The data conversion unit 104 converts the data delivered from the hierarchical data association unit 102 into a form, which can be stored in the data body 107, and sends the data to the data management unit 105. (3) The data management unit 105 sends the data received from the data conversion unit 104 to the data access unit 106. (4) The data access unit 106 stores the data received from the data management unit 105 in the data body 107.

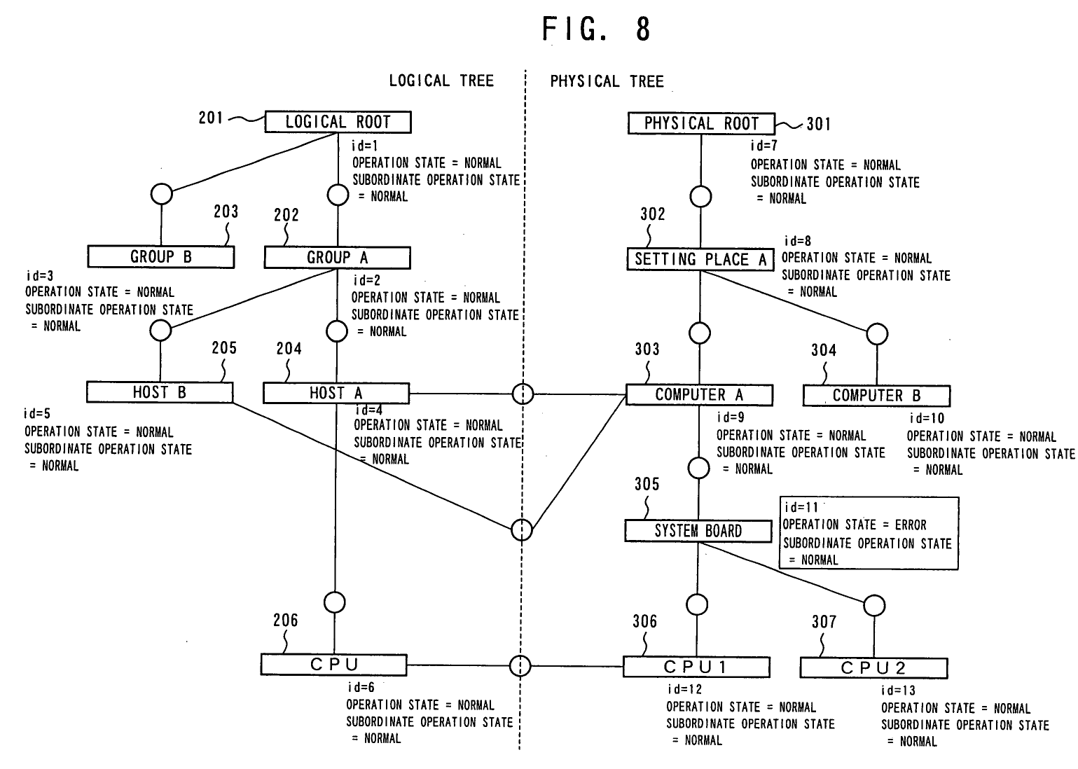

FIG. 8 shows a situation in which an error is detected as a state in a “system board” that is a component of physical hierarchical data (physical tree) by the state detection unit 101 (state detection step). As shown in the figure, the detected state “error” is reflected on an “operation state” of attribute data of the “system board”. This reflection processing for the “error” is performed by updating the attribute data of the component. Here, the hierarchical data association unit 102 performs update of the attribute data of the component (processing for reflecting the detected state) on the basis of information received from the state detection unit 101.

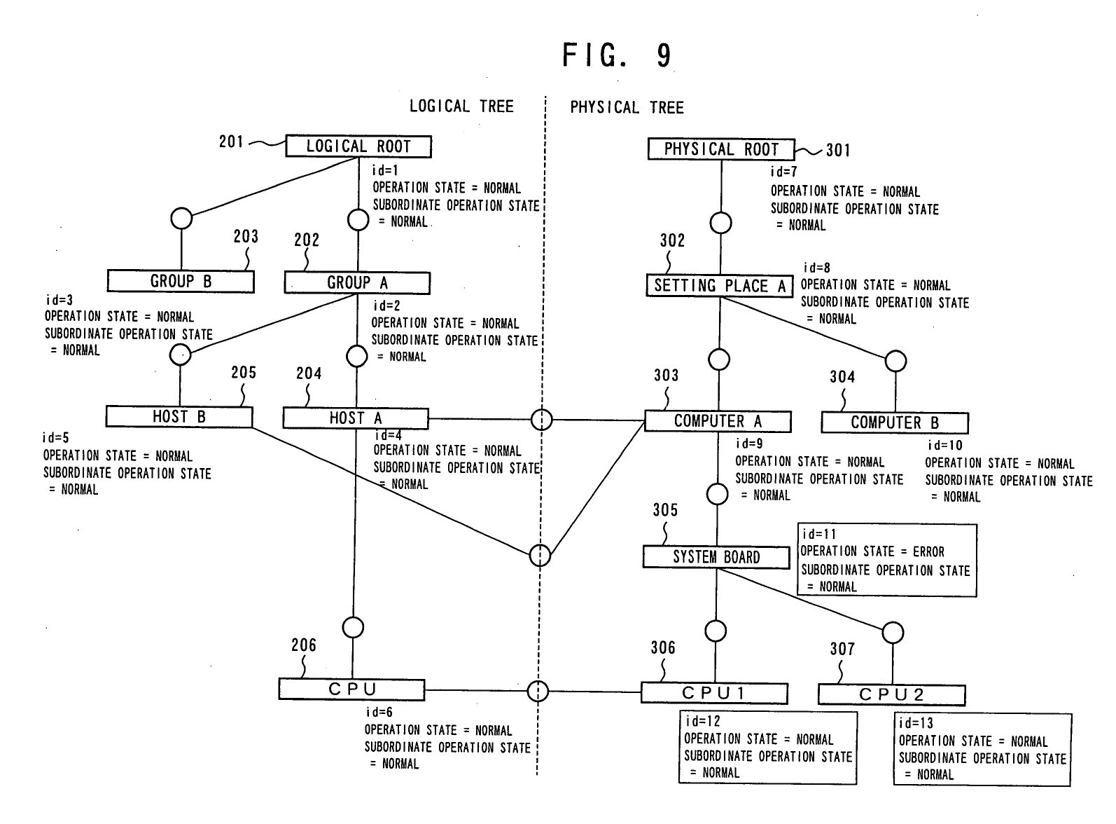

Next, as shown in FIG. 9, the operation state “error” detected in the “system board” and operation states of components (here, a CPU 1 and a CUP 2) lower in order than the “system board” in the tree are compared to determine a subordinate operation state in the attribute data of the “system board”. Here, since the operation states of the CPU 1 and the CPU 2 are normal, the subordinate operation state is “normal”.

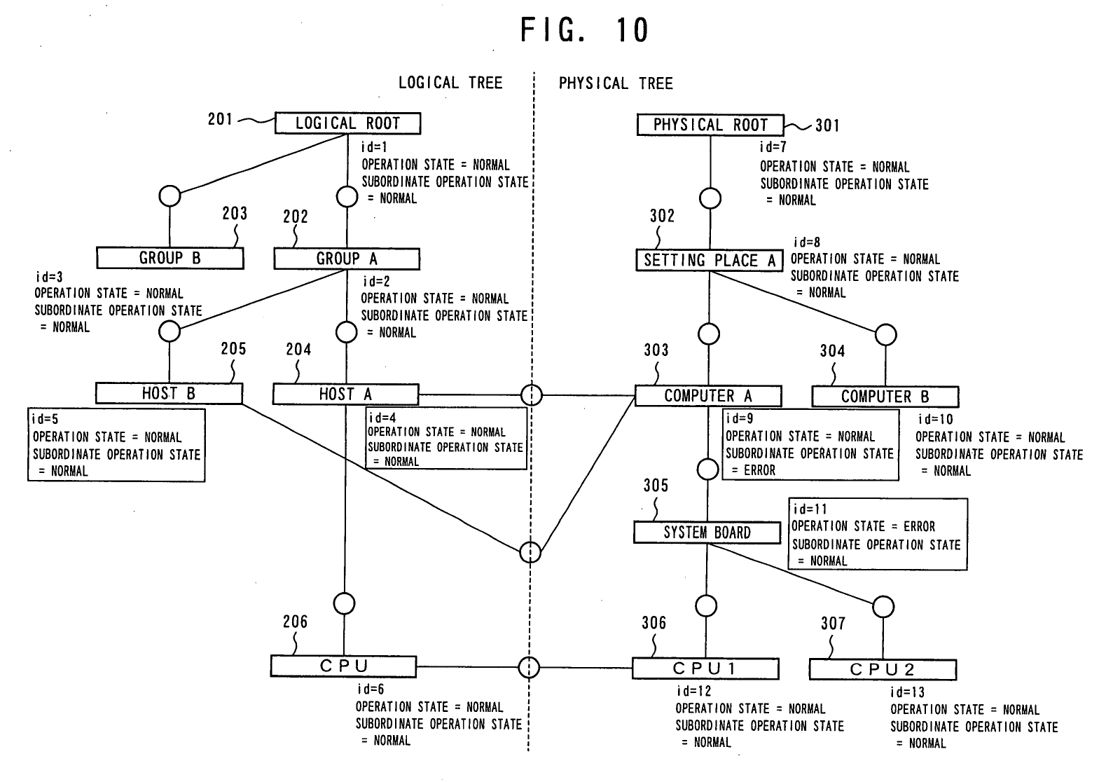

FIG. 10 shows propagation (reflection) of a state to components (a computer A, etc.) higher in order than the “system board” in the physical tree.

Here, since abnormality or the like of an operation state of the “computer A” itself has not been detected, an “operation state” of attribute data of the “computer A” is “normal”.

Next, a “subordinate operation state” of the attribute data of the “computer A” is determined on the basis of operation states of physical components lower in order than this “computer A” and operation states of logical components that are in a connection state with (associated with) the “computer A”. More specifically, the “operation state (error)” of the attribute data of the “system board” and an “operation state (normal)” of attribute data of a “host A” are compared, and an operation state with a higher in order degree of significance (here, error) is set as a “subordinate operation state” of attribute data of the “computer A”.

Note that, in order to perform propagation of a state in the logical tree, the “host A” and a “host B”, which are logical components associated with the “computer A”, are stored in a not-shown storage area as start points for propagation processing.

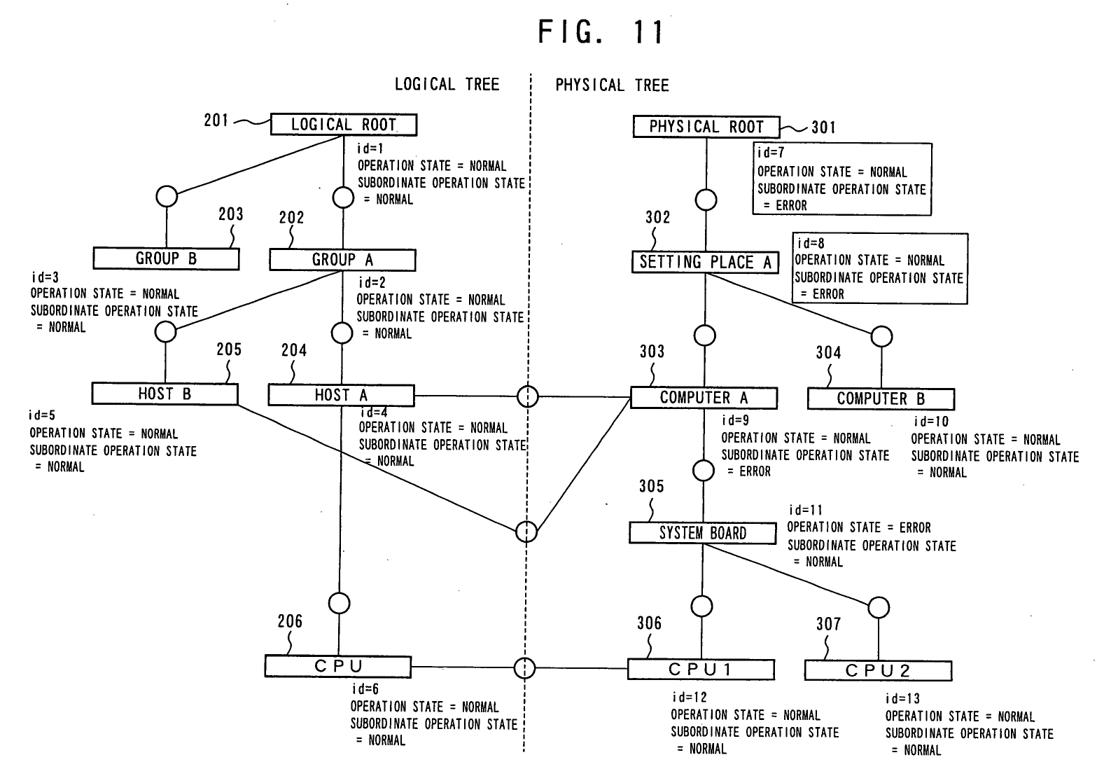

Subsequently, as shown in FIG. 11, the state “error”, which is reflected on the “subordinate operation state” of the attribute data of the “computer A”, is reflected on “subordinate states” of attribute data of a “setting place A” and a “physical Root (a top-level hierarchy of the physical tree)” that are physical components of a hierarchy higher in order than the “computer A”.

In other words, a component, for which a state is detected by the state detection unit, is displayed with the detected state reflected thereon, and components of a hierarchy higher in order than a hierarchy, to which an arbitrary component belongs, are displayed with a state of the arbitrary component reflected thereon.

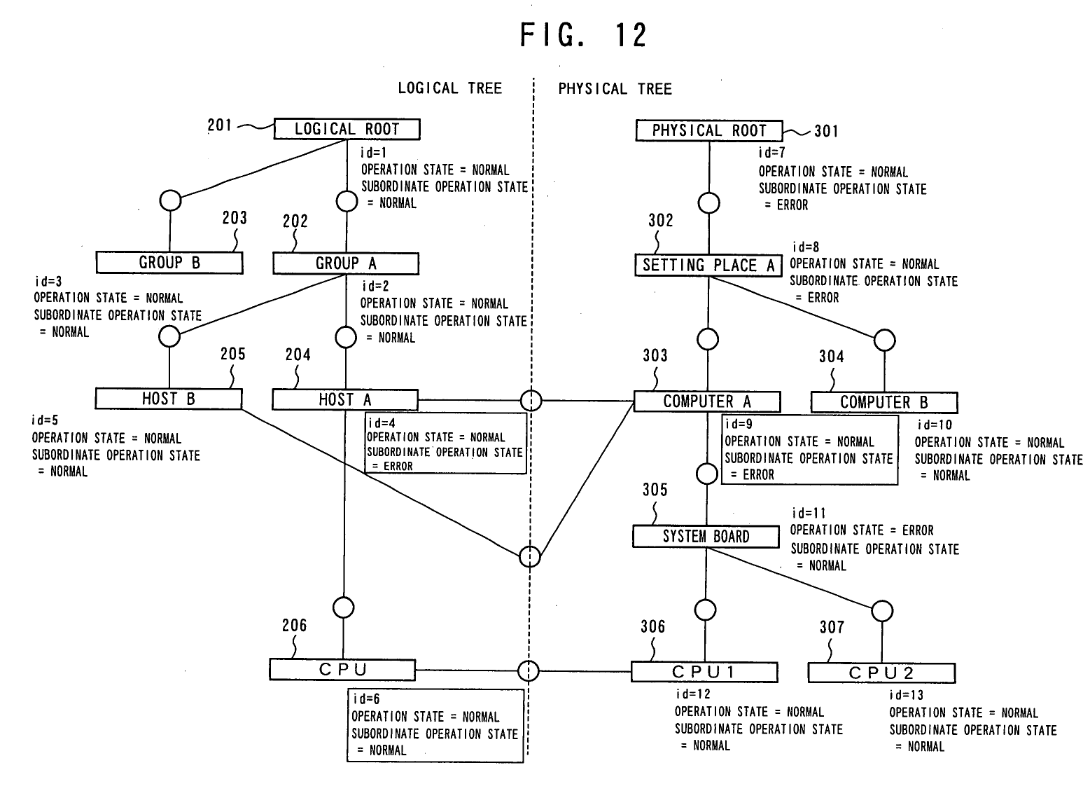

After completing the propagation (reflection) of the operation state in the physical tree, propagation of an operation state to components in the logical tree is performed. First, as shown in FIG. 12, propagation of the operation state to the components in the logical tree is performed with the “host A” as a start point. Here, the “subordinate operation state” of the “computer A”, which is a physical component in a connection relation with the “host A” and the “subordinate operation state” of the logical component “CPU” of a hierarchy subordinate to the “host A” are compared to determine a “subordinate operation state” in the attribute data of the “host A”. Here, the “subordinate operation state” in the attribute data of the “host A” is “error”. In other words, a physical component and a logical component, which are associated with each other, are displayed with a state of one of the physical component and a logical component reflected on the other. Thus, propagation processing for a state from the logical component to physical hierarchical data in the case in which an error or the like has occurred in the logical component can be performed in the same manner as described above.

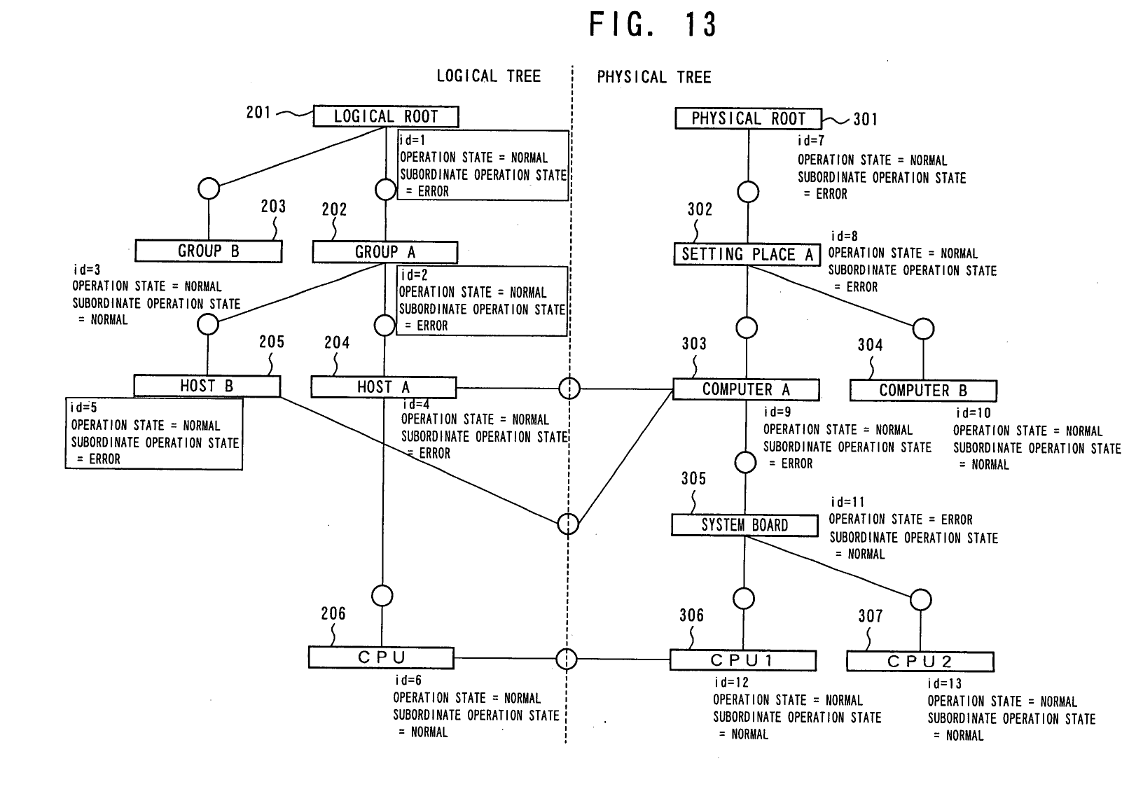

Next, as shown in FIG. 13, propagation of a state is also performed for logical components in hierarchies higher in order than the “host A”. Consequently, “subordinate operation states” in attribute data of a “group A” and a “logical Root” are “error”. Subsequently, propagation processing of an operation state is performed with the “host B”, which is stored as another start point, as a start point. Consequently, a “subordinate operation state” in attribute data of the “host B” is “error”.

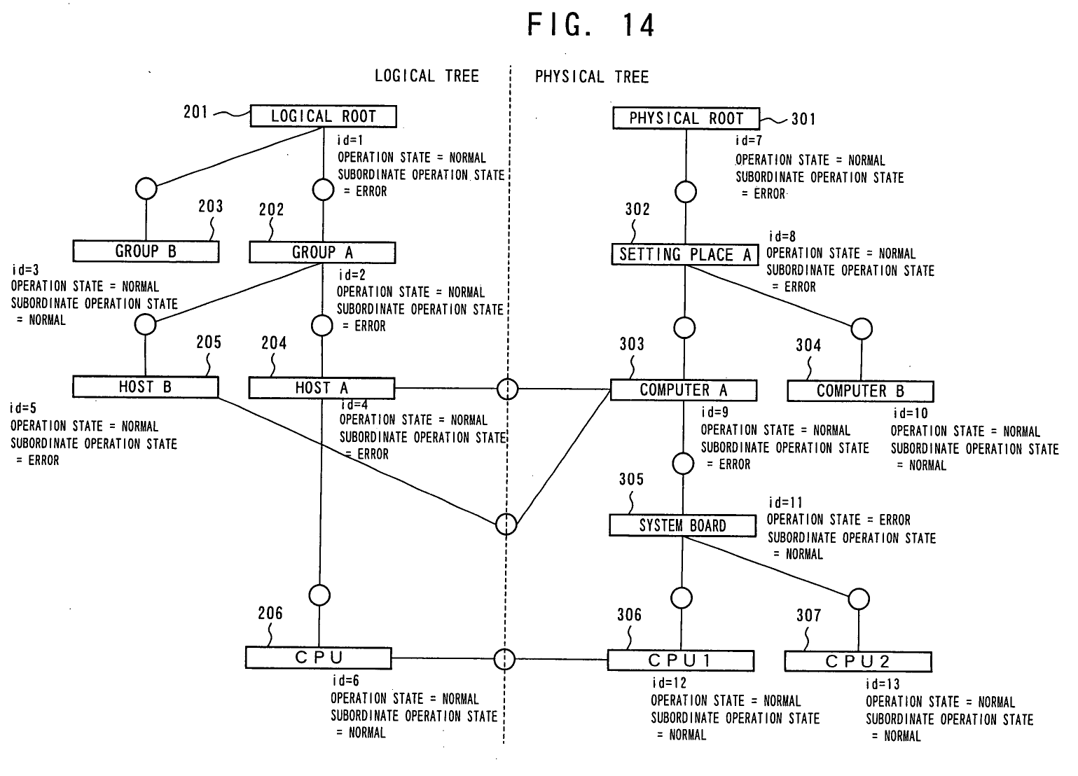

FIG. 14 shows a state in which propagation (reflection) processing for an error, which has occurred in the physical component “system board”, is completed. By performing such processing, it can be determined which range of the physical hierarchical data and the logical hierarchical data is affected by a state that has occurred in a certain component.

Consequently, it is easy to grasp which range of logical components in the logical hierarchical data is affected by an error or the like that has occurred in a physical component. In addition, it is easy to grasp which range of physical components in the physical hierarchical data is affected by the error or the like, which has occurred in a logical component, or to grasp which physical component is a cause of the error or the like. In other words, a source of occurrence of an error can be grasped in a short time, and it can be grasped in a short time which range of work is affected by the error.

As described above, attribute data inherent in each component holds information on two states, namely, a state of the node itself and a state of nodes of hierarchies lower in order than the node in a tree structure. A subordinate tree state is used when an error is represented on a tree, and a state of a node itself is used for confirmation of an error of the node itself. Consequently, it becomes possible to represent the state of the node itself and a range affected by the error separately.

As described above, the hierarchical data shown in FIGS. 7 to 14 indicate a concept of the hierarchical data stored in the hierarchical data setting unit D. It goes without saying that it is also possible to display the same image as shown in the figures on the hierarchical data display unit 108.

When the propagation processing for an operation state described above is performed, for example, the screen display as shown in FIGS. 2A and 3A is performed by the hierarchical data display unit 108. FIGS. 2A and 3A show a case in which some abnormality of an operation state has been detected for the “CPU 1” in the physical hierarchical data and the “CPU” in the logical hierarchical data by the state detection unit 101. Here, the detected abnormality of an operation state is represented as “warning”. Note that the abnormality of an operation state includes “warning”, “error”, and the like, which are represented by “!”, “X”, and the like on a tree display (see FIGS. 2A to 3B).

Note that the respective operations of the computer configuration display apparatus and the computer configuration display method according to this embodiment are realized by storing a computer configuration display program, which is stored in a not-shown storage area in the computer configuration display apparatus, in a recording medium readable by a computer (not-shown CPU) and causing the computer to execute the computer configuration display program. Note that, in the present invention, the recording medium readable by the computer includes portable recording media such as a CD-ROM, a flexible disk, a DVD disk, a magneto-optical disk, and an IC card, a database holding a computer program, or other computers and databases therefor, and also includes a transmission medium on a line.

More specifically, the computer configuration display program according to this embodiment is constituted to cause a computer to execute: a hierarchical data association step of associating physical hierarchical data, which defines plural physical components of a computer as plural hierarchical data according to a predetermined physical segmentation, and logical hierarchical data, which defines plural logical components of the computer as plural hierarchical data according to a predetermined logical segmentation, with each other; a hierarchical data setting step of setting the associated physical hierarchical data and logical hierarchical data; and a hierarchical data display step of displaying the physical hierarchical data and the logical hierarchical data set in the hierarchical data setting step.

In addition, in such a computer configuration display program, it is preferable to include a storage step of storing correspondence relation data that defines a correspondence relation between the physical hierarchical data and the logical hierarchical data, wherein the hierarchical data association step associates the physical hierarchical data and the logical hierarchical data on the basis of the correspondence relation data.

Moreover, in the computer configuration display program as described above, it is also possible to include a state detection step of detecting states of the physical components and the logical components of the computer, wherein the hierarchical data display step displays a component, for which a state is detected in the state detection step, with the detected state reflected thereon, and also displays components of hierarchies higher in order than a hierarchy, to which an arbitrary component belongs, with a state of the arbitrary component reflected thereon. Note that, in the hierarchical data display step, it is desirable to display a physical component and a logical component, which are associated with each other, with a state of one of the physical component and the logical component reflected on the other. In addition, the states in this context include abnormalities, which occur in the physical components or the logical components, or changes to the physical components or the logical components.

Note that, in the computer configuration display program as described above, the hierarchical data display step can display the physical hierarchical data and the logical hierarchical data, which are associated with each other in the hierarchical data association step, such that the physical hierarchical data and the logical hierarchical data can be switched.

(Second Embodiment)

Subsequently, a second embodiment of the invention will be explained. This embodiment is a modification of the first embodiment and is different from the first embodiment in processing at the time when a change in a state occurs in a predetermined physical component or a predetermined logical component. In the following explanation, components having the identical functions as the components already described in the first embodiment are denoted by the identical reference numerals and signs and explanations of the components are omitted.

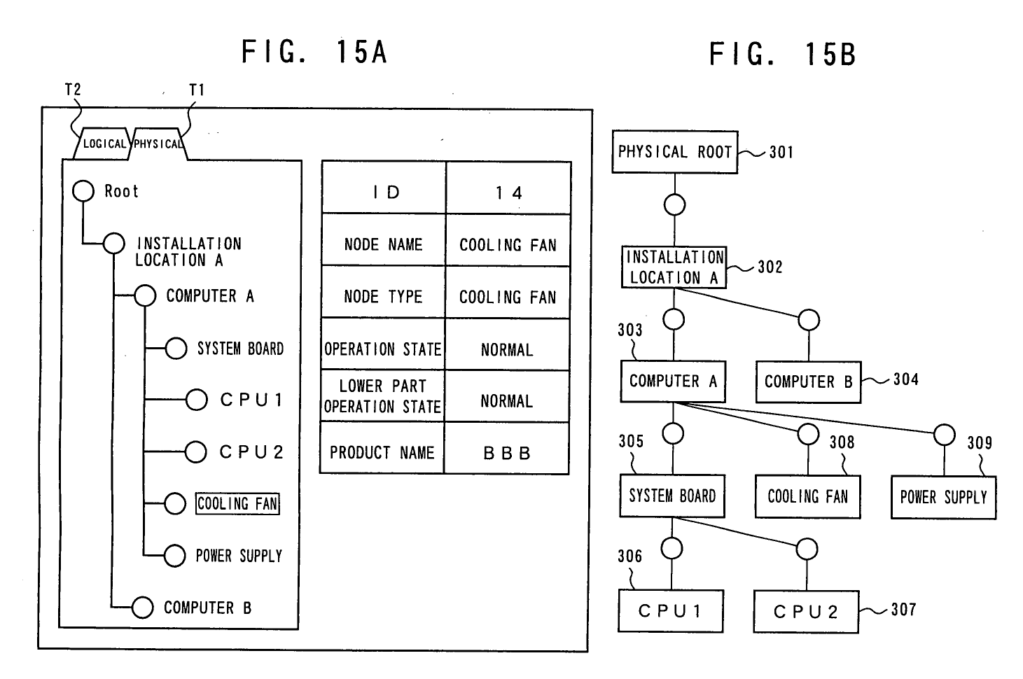

FIG. 15A is a diagram for explaining an example of screen display of a physical hierarchical data and FIG. 15B is a diagram showing a hierarchical structure of the physical hierarchical data. In the physical hierarchical data shown in the figure, a cooling fan 308 and a power supply 309 are included in the same hierarchy as the system board 305 of the physical hierarchical data shown in FIGS. 3A and 3B in the first embodiment. Here, when a change occurs in a state of a physical component, which is not directly related to a function of an operating system or management thereof, such as the cooling fan 308 or the power supply 309, it is difficult to reflect (propagate) the change in the state of the physical component to a specific logical component in logical hierarchical data. Such a problem also occurs, in the event that a change occurs in a state of a specific logical component, when a physical component in a correspondence relation with the logical component cannot be specified clearly.

In such physical hierarchical data, for example, in the event that a change occurs in a state of the cooling fan 308, when a sheet of physical hierarchical data is displayed in the hierarchical data display unit 108, a user can recognize a state reflected by the hierarchical data association unit 102. On the other hand, when a sheet of logical hierarchical data is displayed in the hierarchical data display unit 108, since a change in a state of the cooling fan 308 is not reflected in a logical component of the logical hierarchical data unlike the above-described case, the user cannot recognize the change in the state of the cooling fan 308 unless the displayed sheet of the logical hierarchical data is switched to the sheet of the physical hierarchical data.

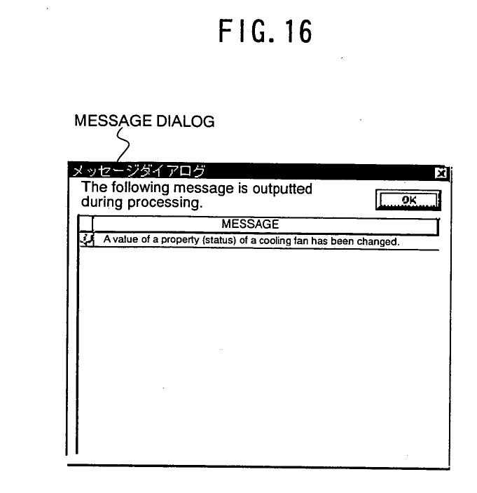

Here, in the event that a change occurs in a state of the cooling fan 308, the power supply 309, or the like, it is also possible to inform the user of the change using a dialog box shown in FIG. 16 (e.g., by displaying the dialog box in the front of a screen). However, the user has to find in which of the logical hierarchical data and the physical hierarchical data the change in the state has occurred on the basis of a component name displayed in the dialog box while switching to display the sheets of the respective hierarchical data. This imposes a burden on a system administrator.

The dialog message is often displayed only at timing when a change in a state occurs anew. Thus, when a dialog box was displayed in the past but the display of the dialog box has disappeared and a sheet of hierarchical data to which a component, in which a change of a state has occurred, belongs is not displayed on a screen, it is likely that the change in the state is not recognized unless the user switches to display the sheet of the hierarchical data.

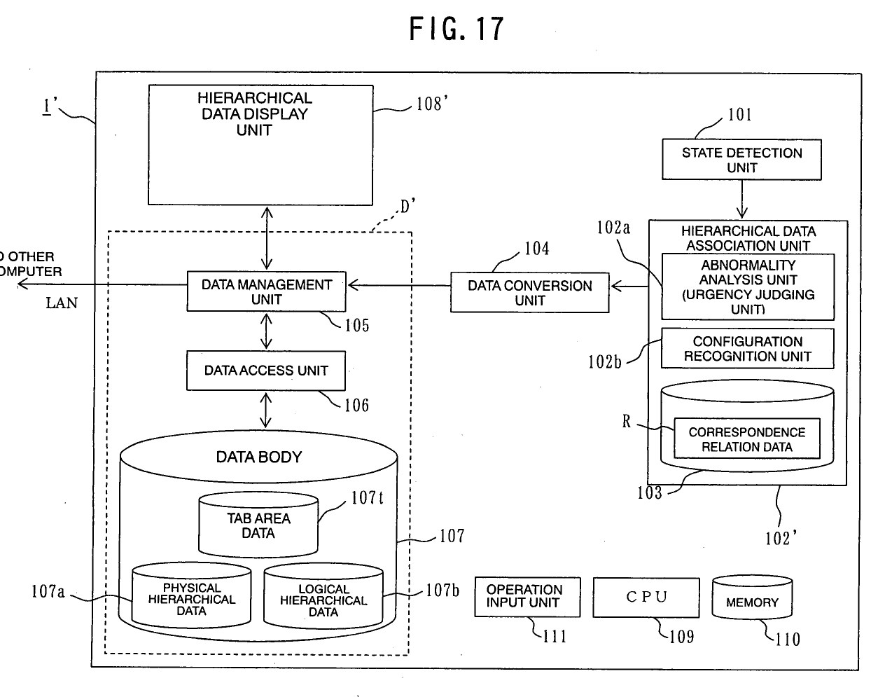

FIG. 17 shows a functional block diagram for explaining a constitution of a computer configuration display apparatus according to the embodiment of the invention for solving the problems described above. A computer configuration display apparatus 1′ according to this embodiment is an apparatus that, in order to manage a computer including plural physical components and logical components, performs display concerning the components of the computer. The computer configuration display apparatus 1′ is arranged inside the computer. In addition, the computer configuration display apparatus 1′ has all the functions that the computer configuration display apparatus 1 according to the first embodiment has.

As shown in the figure, the computer configuration display apparatus 1′ according to this embodiment includes the state detection unit 101, a hierarchical data association unit 102′, the data conversion unit 104, a hierarchical data setting unit D′, a hierarchical data display unit 108′, a memory 110 serving as a storage area, a CPU 109, and an operation input unit 111.

The hierarchical data association unit 102′ has the same function as the hierarchical data association unit 102 in the first embodiment and has functions of an abnormality analysis unit 102a and a configuration recognition unit 102b. The configuration recognition unit 102b has a role of acquiring information on components of a system in a computer in which the computer configuration display apparatus 1′ according to this embodiment is arranged, transmitting the information to the data management unit 105 via the data conversion unit 104 as a data group of a tree structure (physical hierarchical data and logical hierarchical data), and registering the information in a database. The abnormality analysis unit 102a has a role of associating a state detected by the state detection unit 101 with the information on the components of the system acquired by the configuration recognition unit 102b and instructing the data management unit 105 to update a state concerning state information of the components. Note that the abnormality analysis unit 102a also has a role as an urgency judging unit that judges a degree of urgency of the state detected by the state detection unit 101.

The hierarchical data display unit 108′ has the same function as the hierarchical data display unit 108 in the first embodiment and has a function of, when a state of a specific component (to be described later) is detected by the state detection unit 101, reflecting and displaying the detected state in a predetermined display area that is an area, which is displayed when any of physical hierarchical data and logical hierarchical data is displayed, and corresponds to hierarchical data to which the specific component belongs. Note that the specific component is at least one of a physical component and a logical component and is a component that is not in a predetermined correspondence relation with the other (a relation in which a state of one of a physical component and a logical component has a predetermined influence on a state of the other such as occurrence of functional failure or occurrence of work like repair or management). More specifically, as the specific component, for example, there are a cooling fan and a power supply that are physical components.

The hierarchical data display unit 108′ has a function of switchably displaying physical hierarchical data and logical hierarchical data on a screen and displays tab sections (equivalent to a tab area and a predetermined display area) in association with the physical hierarchical data and the logical hierarchical data, respectively (see T1 and T2 in FIG. 15A). The hierarchical data display unit 108′ selects the tab sections on the basis of operation input received by the operation input unit 111 and switches hierarchical data to be displayed. These tab sections are areas, which are displayed even when any of the physical hierarchical data and the logical hierarchical data is displayed, and are equivalent to a predetermined display area corresponding to hierarchical data to which a specific component belongs.

The hierarchical data setting unit D′ has the same function as the hierarchical data setting unit D in the first embodiment. In the data body 107 in the hierarchical data setting unit D′, tab area data 107t is stored in addition to physical hierarchical data 107a and logical hierarchical data 107b.

Note that the state detection unit 101, the data conversion unit 104, the memory 110, and the CPU 101 have the same functions as the first embodiment. Here, the memory 110 is equivalent to a not-shown storing unit and the CPU 109 is equivalent to a not-shown control unit. In addition, the operation input unit 111 is constituted by a keyboard, a mouse, or the like and has a role of receiving operation input from a user. Note that functions of a display, which performs screen display according to the hierarchical data display unit 108′, and the operation input unit 111 may be realized by a touch panel display or the like.

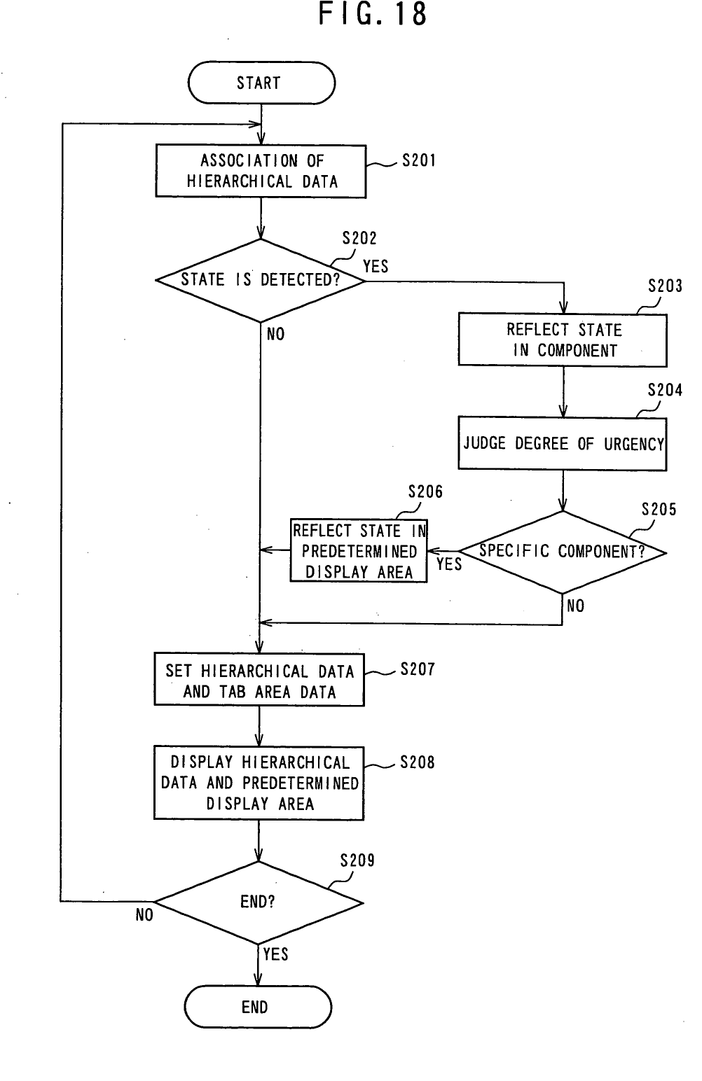

Subsequently, an operation of the computer configuration display apparatus according to this embodiment will be explained. FIG. 18 is a flowchart for explaining a flow of processing in a computer configuration display method according to this embodiment.

The abnormality analysis unit 102a transmits information on components and data recognized by the configuration recognition unit 102b to the data management unit 105 at timing when a program is started in the computer, when a configuration of the system is changed, or the like. Among the data transmitted to the data management unit 105 in this way, information concerning physical components is stored as the physical hierarchical data (hierarchical data defining plural physical components of the computer as plural hierarchical data according to a predetermined physical segmentation) 107a . In addition, information concerning logical components is stored as the logical hierarchical data (hierarchical data defining plural logical components of the computer as plural hierarchical data according to a predetermined logical segmentation) 107b.

The hierarchical data association unit 102′ associates the physical hierarchical data 107a and the logical hierarchical data 107b on the basis of correspondence relation data R (hierarchical data association step) (S201).

Subsequently, states of physical components and logical components of the computer (presence or absence of error or alarm, etc.) are detected by the state detection unit 101 (state detection step) (S202).

If some state is detected (Yes in S202), the detected state is reflected in the component for which the state is detected by the state detection unit 101 (S203). Note that, in processing for reflecting the detected state, a flag representing the state may be set for data concerning the component by the hierarchical data association unit 102 or the hierarchical data setting unit D′ or the state may be reflected in a corresponding component when the data is displayed on a screen in a hierarchical data display step to be described later.

After the processing for reflecting the detected state in the component (S203), a degree of emergency of the state is judged by the abnormality analysis unit (urgency judging unit) 102a (urgency judging step) (S204). Thereafter, if the component for which the state is detected is a specific component (Yes in S205), the abnormality analysis unit 102a requests the data management unit 105 to reflect the state in the tab area data 107t (S206).

After the above-described processing (S203 and S206), if no state is detected (No in S202) or if the component for which the state is detected is not a specific component (No in S205), states of the tab area data 107t, the physical hierarchical data 107a, and the logical hierarchical data 107b and degrees of urgency of the data (or display contents corresponding to the degrees of urgency) are set (stored) by the hierarchical data setting unit D′ (hierarchical data setting step) (S207).

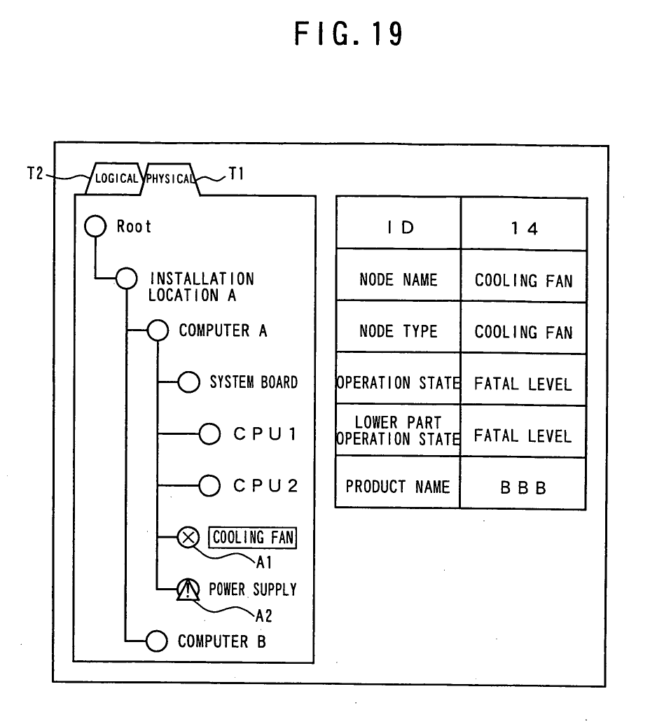

Then, the tab area data 107t, the physical hierarchical data 107a, and the logical hierarchical data 107b, in which the state set by the hierarchical data setting unit D′ is reflected, are displayed by the hierarchical data display unit 108′ (hierarchical data display step) (S208). Note that the display of the tab areas, the physical hierarchical data, and the logical hierarchical data is performed on the basis of the latest tab area data 107t, physical hierarchical data 107a, and logical hierarchical data 107bthat are acquired from the data body 107 via the data management unit 105. FIG. 19 shows an example of display at the time when a failure state, in which drive for the cooling fan 308 stops, occurs and a failure state, in which it is possible to continue an operation partially for the power supply 309, occurs.

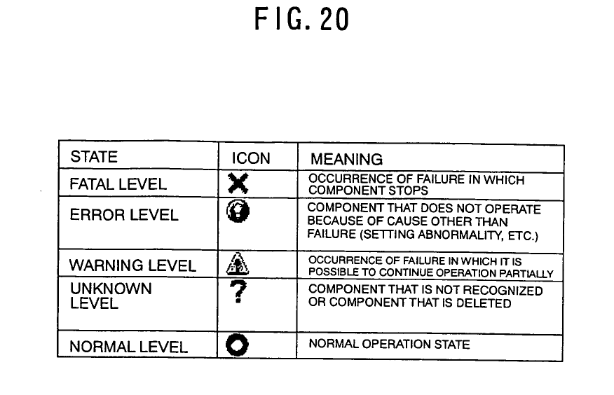

The hierarchical data display unit 108′ performs reflection and display of a state based on a degree of urgency set by the hierarchical data setting unit D′ when the tab areas, the physical hierarchical data, and the logical hierarchical data are displayed. FIG. 20 is a diagram showing examples of types of levels of a degree of urgency and icon display that is defined in association with the respective urgency level. In the figure, as the level of a degree of urgency, a “Fatal level” meaning occurrence of a failure in which a component stops, an “Error level” meaning a component that does not operate because of a cause other than a failure, a “Warning level” meaning occurrence of a failure in which it is possible to continue an operation partially, an “Unknown level” meaning a component that is not recognized, a component that is deleted, or the like, and a “normal level” meaning that a component is in a normal operation state other than the abnormal states described above. Note that information defining the levels of a degree of urgency shown in FIG. 20 can be stored in, for example, the data body 107 and the memory 110.

The hierarchical data display unit 108′ displays an icon Al and an icon A2 (see FIG. 20) corresponding to degrees of urgency of the cooling fan 308 and the power supply 309 on the basis of the information set by the hierarchical data setting unit D′.

After the above-described processing (S208), if the processing is continued (No in S209), the computer configuration display apparatus returns to the processing (S201). If the processing is ended (Yes in S209), the computer configuration display apparatus ends the processing.

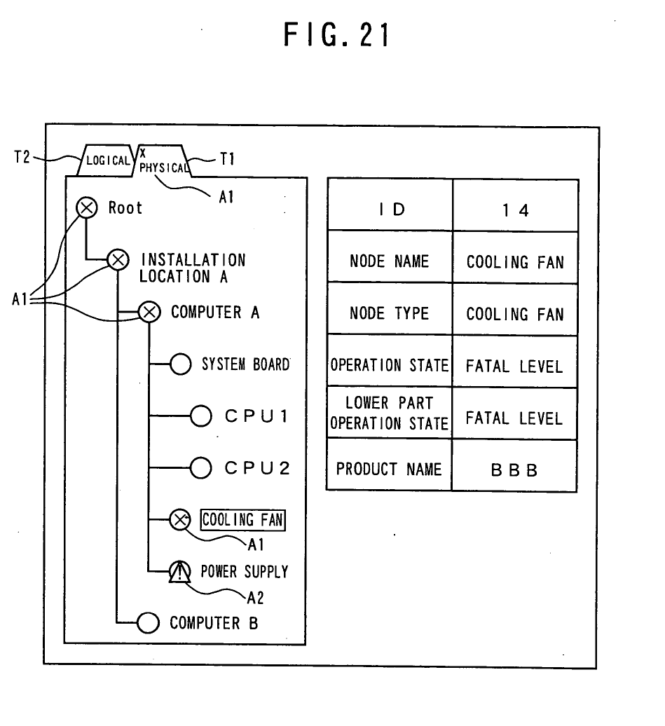

The hierarchical data display unit 108′ reflects and displays the detected state in the component (e.g., the cooling fan 308 and the power supply 309) for which the state is detected in the state detection unit 101 (see FIG. 19) and reflects and displays the state of the component in components in higher-order hierarchies to which the component belongs (here, a computer A, an installation location A, and a Root) (see FIG. 21). Note that, when states of plural specific components in hierarchical data are detected by the state detection unit 101, the hierarchical data display unit 108′ reflects and displays a state with a highest degree of urgency judged by the abnormality analysis unit (the urgency judging unit) 102a in components in higher-order hierarchies and the tab area T1 (i.e., displays the icon A1 corresponding to the state reflected in the component Root in the top hierarchy in the tab area T1).

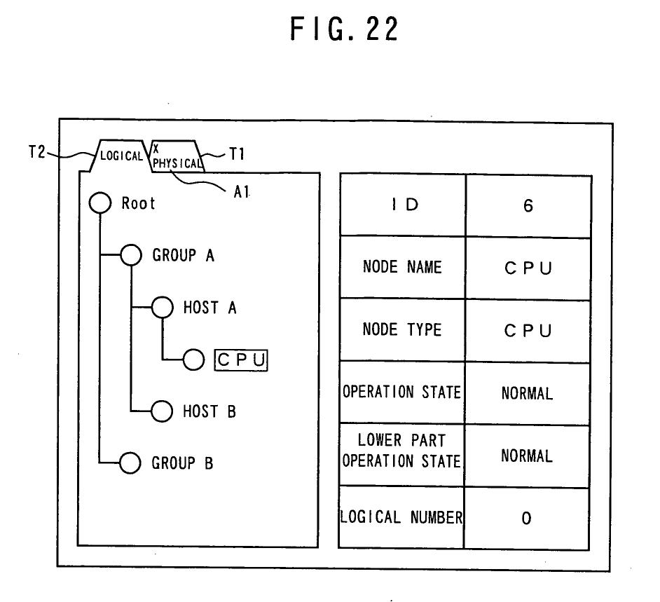

In addition, when hierarchical data of one of the physical hierarchical data and the logical hierarchical data is displayed, the hierarchical data display unit 108′ reflects and displays a state, which is detected for a specific component in the other hierarchical data, in a predetermined display area. Thus, when the state of the “Fatal level” occurs in the cooling fan 308 as in the example shown in FIG. 19, even in a state in which the logical hierarchical data is displayed in the hierarchical data display unit 108′, the icon A1 representing the state of the “Fatal level” is displayed in the tab area T1 corresponding to the physical hierarchical data as shown in FIG. 22. Consequently, a user is capable of grasping a change in a state of hierarchical data, which cannot be visually recognized by switching of display to any of the hierarchical data, without switching display of the hierarchical data.

Note that, in the case in which a state of a specific component in the physical hierarchical data or the logical hierarchical data is reflected and displayed in the tab area, when states of all specific components in the physical hierarchical data and the logical hierarchical data are restored by maintenance or the like of the computer and are detected as a predetermined normal state (FIG. 20) by the state detection unit 101, the hierarchical data display unit 108′ changes display for reflecting a state of the tab area to display corresponding to the predetermined normal state (e.g., deletes the icon display or changes the icon to an icon of a “normal level” in FIG. 20). Consequently, when the state of the specific component is returned to the predetermined normal state, it is possible to cause the user to easily grasp that the state is returned to the normal state without confirming the state according to switching display of the hierarchical data.

Note that the respective operations of the computer configuration display apparatus and the computer configuration display method in this embodiment are realized by causing the CPU 109 to execute a computer configuration display program stored in the memory 110 in the computer configuration display apparatus. Examples of a storage medium storing the computer configuration display program include portable storage media such as a CD-ROM, a flexible disk, a DVD disk, a magneto-optical disk, and an IC card, a database holding a computer program, other computers, databases for the computers, and a transmission medium on a line.

As described above, according to this embodiment, in addition to the effects realized by the first embodiment, the following effects are realized. When a change in a state of a physical component or a logical component occurs (at the time of occurrence of abnormality, etc.), an icon, in which the state is reflected, is displayed in a tab area for switching display of physical hierarchical data and logical hierarchical data, whereby it is possible to grasp occurrence of abnormality or the like in hierarchical data, which is not displayed, easily and intuitively without selecting a tab area to switch a sheet. In addition, after the state of the component, in which the change occurs in the state, is recovered, it is possible to confirm whether other abnormality remains easily without switching display of the hierarchical data.

In the example described in this embodiment, the change in the state occurs in the specific component in the physical components. However, it is needless to mention that the invention is not limited to this and the same effects are realized when some change in a state occurs in a specific component in logical components. In addition, in this embodiment, the tab section is referred to as an example of the predetermined display area. However, the invention is not limited to this and, for example, it is also possible to always provide an area, in which a screen is displayed, and a window when any of hierarchical data is displayed and reflect and display a change in a state of a specific component in the display area.

Note that, in the respective embodiments described above, the physical components define a path of a signal and a structure of a mounted component and are equivalent to components constituting a system. More specifically, examples of the physical components include an apparatus housing, a power supply, a cooling fan, a data bus, a system board, a CPU, a memory, a magnetic disk device, a magnetic disk, an extension housing, and an extension card.

In addition, the logical components are constituted from the viewpoint of a constitution of a driver, resources managed by an OS, and the like and are equivalent to components as resources that are used from the OS. More specifically, examples of the logical components include a CPU, a memory, a magnetic disk, and an extension card.

As described above in detail, according to the present invention, it is possible to provide a computer configuration display apparatus, a computer configuration display method, and a computer configuration display program that can contribute to reduction of a burden on a system administrator who performs management concerning physical components and logical components of a computer.

1. A computer configuration display apparatus comprising:
a hierarchical data association unit that associates physical hierarchical data, which defines plural physical components of a computer as plural hierarchical data according to a predetermined physical segmentation, and logical hierarchical data, which defines plural logical components of the computer as plural hierarchical data according to a predetermined logical segmentation, with each other;
a hierarchical data setting unit that sets said associated physical hierarchical data and logical hierarchical data; and
a hierarchical data display unit that displays said physical hierarchical data and said logical hierarchical data set in said hierarchical data setting unit.

2. The computer configuration display apparatus according to claim 1, further comprising a storage unit that stores correspondence relation data defining a correspondence relation between said physical hierarchical data and said logical hierarchical data,
wherein said hierarchical data association unit associates said physical hierarchical data and said logical hierarchical data with each other on the basis of said correspondence relation data.

3. The computer configuration display apparatus according to claim 1, further comprising a state detection unit that detects states of said physical components and said logical components of the computer,
wherein said hierarchical data display unit displays a component, for which a state is detected by said state detection unit, with the detected state reflected thereon, and displays components of hierarchies higher in order than a hierarchy, to which an arbitrary component belongs, with a state of the arbitrary component reflected thereon.

4. The computer configuration display apparatus according to claim 3, wherein, when a state of a specific component is detected by the state detection unit, the hierarchical data display unit reflects and displays the detected state in a predetermined display area that is an area, which is displayed even when any of physical hierarchical data and logical hierarchical data is displayed, and corresponds to hierarchical data to which the specific component belongs.

5. The computer configuration display apparatus according to claim 4,
wherein said hierarchical data display unit displays a physical component and a logical component, which are associated with each other, with a state of one of said physical component and said logical component reflected on the other.

6. The computer configuration display apparatus according to claim 4,
wherein said states include abnormalities, which occur in said physical components or said logical components, or changes to said physical components or said logical components.

7. The computer configuration display apparatus according to claim 4,
wherein said hierarchical data display unit displays said physical hierarchical data and said logical hierarchical data, which are associated with each other by said hierarchical data association unit, such that said physical hierarchical data and said logical hierarchical data can be switched.

8. A computer configuration display method comprising:
a hierarchical data association step of associating physical hierarchical data, which defines plural physical components of a computer as plural hierarchical data according to a predetermined physical segmentation, and logical hierarchical data, which defines plural logical components of the computer as plural hierarchical data according to a predetermined logical segmentation, with each other;
a hierarchical data setting step of setting said associated physical hierarchical data and logical hierarchical data; and
a hierarchical data display step of displaying said physical hierarchical data and said logical hierarchical data set in said hierarchical data setting step.

9. The computer configuration display method according to claim 8, further comprising a storage step of storing correspondence relation data defining a correspondence relation between said physical hierarchical data and said logical hierarchical data,
wherein said hierarchical data association step associates said physical hierarchical data and said logical hierarchical data with each other on the basis of said correspondence relation data.

10. The computer configuration display method according to claim 8 or 9, further comprising a state detection step of detecting states of said physical components and said logical components of the computer,
wherein said hierarchical data display step displays a component, for which a state is detected in said state detection step, with the detected state reflected thereon, and displays components of hierarchies higher in order than a hierarchy, to which an arbitrary component belongs, with a state of the arbitrary component reflected thereon.

11. The computer configuration display method according to claim 10, wherein, when a state of a specific component is detected in the state detection step, in the hierarchical data display step, the detected state is reflected and displayed in a predetermined display area that is an area, which is displayed even when any of physical hierarchical data and logical hierarchical data is displayed, and corresponds to hierarchical data to which the specific component belongs.

12. The computer configuration display method according to claim 11,
wherein said hierarchical data display step displays a physical component and a logical component, which are associated with each other, with a state of one of said physical component and said logical component reflected on the other.

13. The computer configuration display method according to claim 11,
wherein said states include abnormalities, which occur in said physical components or said logical components, or changes to said physical components or said logical components.

14. The computer configuration display method according to claim 11,
wherein said hierarchical data display step displays said physical hierarchical data and said logical hierarchical data, which are associated with each other in said hierarchical data association step, such that said physical hierarchical data and said logical hierarchical data can be switched.

15. A computer configuration display program that causes a computer to execute:
a hierarchical data association step of associating physical hierarchical data, which defines plural physical components of a computer as plural hierarchical data according to a predetermined physical segmentation, and logical hierarchical data, which defines plural logical components of the computer as plural hierarchical data according to a predetermined logical segmentation, with each other;
a hierarchical data setting step of setting said associated physical hierarchical data and logical hierarchical data; and
a hierarchical data display step of displaying said physical hierarchical data and said logical hierarchical data set in said hierarchical data setting step.

16. The computer configuration display program according to claim 15, further comprising a storage step of storing correspondence relation data defining a correspondence relation between said physical hierarchical data and said logical hierarchical data,
wherein said hierarchical data association step associates said physical hierarchical data and said logical hierarchical data with each other on the basis of said correspondence relation data.

17. The computer configuration display program according to claim 15 or 16, further comprising a state detection step of detecting states of said physical components and said logical components of the computer,
wherein said hierarchical data display step displays a component, for which a state is detected in said state detection step, with the detected state reflected thereon, and displays components of hierarchies higher in order than a hierarchy, to which an arbitrary component belongs, with a state of the arbitrary component reflected thereon.

18. The computer configuration display program according to claim 17, wherein, when a state of a specific component is detected in the state detection step, in the hierarchical data display step, the detected state is reflected and displayed in a predetermined display area that is an area, which is displayed even when any of physical hierarchical data and logical hierarchical data is displayed, and corresponds to hierarchical data to which the specific component belongs.

19. The computer configuration display program according to claim 18,
wherein said hierarchical data display step displays a physical component and a logical component, which are associated with each other, with a state of one of said physical component and said logical component reflected on the other.

20. The computer configuration display program according to claim 18,
wherein said states include abnormalities, which occur in said physical components or said logical components, or changes to said physical components or said logical components.

21. The computer configuration display program according to claim 18
wherein said hierarchical data display step displays said physical hierarchical data and said logical hierarchical data, which are associated with each other in said hierarchical data association step, such that said physical hierarchical data and said logical hierarchical data can be switched.
